(19) United States
(12) Patent Application Publication
(10) Pub. No.: US 2013/0117831 A1
(43) Pub. Date: May 9, 2013

(54) METHOD AND SYSTEM FOR ENABLING COMPUTER ACCESS

(71) Applicants: David Geoffrey Hook, Ascot Vale (AU); Richard Hans Harvey, Ringwood East (AU)

(72) Inventors: David Geoffrey Hook, Ascot Vale (AU); Richard Hans Harvey, Ringwood East (AU)

(73) Assignee: LOCK BOX PTY LTD, South Yarra, Vic (AU)

(21) Appl. No.: 13/643,406

(22) PCT Filed: Apr. 7, 2011
(86) PCT No.: PCT/AU11/00401

§ 371 Date: Jan. 4, 2013

(30) Foreign Application Priority Data
Apr. 30, 2010 (AU) 2010901853

(51) Int. Cl. H04L 29/06

(52) U.S. Cl. CPC H04L 63/0838; H04L 63/0823
USPC 726/6

(57) ABSTRACT

The present invention relates to the filed of computer access and in particular remote authentication. In one form, the invention relates to one time passwords used in computer or web-based systems. In one particular aspect, the present invention is suitable for use with certificate based credentials.

### FIELD OF INVENTION

The present invention relates to the field of computer access and In particular remote authentication.

In one form, the invention relates to one time passwords used in computer or web-based systems.

In one particular aspect, the present invention is suitable for use with certificate based credentials.

It will be convenient to hereinafter describe the invention in relation to web access making use of certificate based credentials, however it should be appreciated that the present invention is not limited to that use only.

### BACKGROUND ART

Throughout this specification the use of the word Inventor in singular form may be taken as reference to one (singular) inventor or more than one (plural) inventor of the present invention.

Typically, most client-server applications use simple credentials, such as account and password and this is particularly true on the web as this is the simplest and easiest mechanism for authentication. However, there are many problems with simple credentials, including poor security (e.g. password guessing, password stealing etc), ongoing maintenance (e.g. registration, provisioning, de-provisioning, password reminders, password reset etc.) and the difficulty for .end users to have to remember account/password combinations for potentially large numbers of applications (e.g. websites). Thus there is a desire for many applications to use strong credentials e.g. certificate based credentials and for these credentials to be used across more than one application.

The inventors have identified a number of problems with enabling existing applications to make use of strong credentials. In particular, enabling existing web applications to use certificate based credentials, especially where it is desirable not to modify either the client application (e.g. web browser) or the server application (e.g. web site).

For example, most corporate Single Sign-On (SSO) systems rely on a central authentication server within a closed network, such as Enterprise SSO (ESSO) via an agent similar to that shown in FIG. 1a, or Kerberos via session tickets similar to that shown in FIG. 1b. Centralised authentication servers often interface to a store of users, e.g. a corporate directory. Whilst corporate SSO systems may use strong credentials for authenticating to the central authentication server, they are generally limited to closed networks where users have logged into a service, (e.g. an organisation with a corporate directory) and are not generally used to provide web SSO, for example with browsers and websites, because of problems with scalability, trust, firewalls, availability, provisioning etc. Also, applications and/or their environment may need to be modified in order to participate in an SSO scheme, for example to acquire, verify and interpret tickets.

In another example, most web SSO systems make use of a separate identity provider to authenticate users, similar to that shown in FIG. 1c, via a security token such as assertions (e.g. Security Assertion Mark-up Language, SAML), query string (e.g. Openld), browser cookie, claims (e.g. CardSpace) etc. Whilst these systems are common on the web, they tend to use passwords instead of using certificate based credentials as they cannot rely on a certificate infrastructure to be in place. Also, applications may need to be modified in order to participate in web SSO systems, for example to redirect logins and/or acquire, verify and interpret security tokens.

Furthermore, most applications that use certificate-based authentication do so via Secure Sockets Layer (SSL) or Transport Layer Security (TLS). In the normal mode of SSLITLS, the certificate of the server is made available to the client on connection. In client authenticated SSL/TLS, in addition a client certificate is made available to the server (also called two-way authentication or mutual authentication) such as shown in FIG. 1d. Client authenticated. SSUTLS systems may be relatively difficult authentication systems to use and manage as they may require a certificate infrastructure to be in place, some convention about the distinguished name (DN) in the client certificate, and/or installation of trusted certificates in both the server (e.g. web server) and client application (e.g. web browser). Whilst client authenticated SSL/TLS may be used within a Public Key Infrastructure (PKI) or a Web of Trust community, it is not generally used for web SSO because of the relatively difficulty for users to install certificates in browsers and the relative cost and complexity of certificate infrastructures.

It is to be appreciated that any discussion of documents, devices, acts or knowledge in this specification is included to explain the context of the present invention. Further, the discussion ,throughout this specification comes about due to the realisation of the inventor and/or the identification of certain related art problems by the inventor. Moreover, any discussion of material such as documents, devices, acts or knowledge in this specification is included to explain the context of the invention in terms of the inventor's knowledge and experience and, accordingly, any such discussion should not be taken as an admission that any of the material forms part of the prior art base or the common general knowledge in the relevant art in Australia, or elsewhere, on or before the priority date of the disclosure and claims herein.

### SUMMARY OF INVENTION

An object of the present invention is to alleviate at least one disadvantage associated with the related art.

It is an object of the embodiments described herein to overcome or alleviate at least one of the above noted drawbacks of related art systems or to at least provide a useful alternative to related art systems.

In a first aspect of embodiments described herein there is provided a method of and/or application adapted to enable a method of generating a temporary authentication credential adapted to enable access to a remote service, comprising providing a certificate based credential, and thereafter generating a temporary authentication credential for use in the access of the remote service.

In another aspect of embodiments described herein there is provided a method of and/or application adapted to a method of enabling access to a remote service, comprising generating a temporary authentication credential, providing to the remote service, the temporary credential and providing the temporary credential to the client for use in enabling access to the remote service.

Other aspects and preferred forms are disclosed In the specification and/or defined in the appended claims, forming a part of the description of the invention.

In essence, embodiments of the present invention stem from the realization that strong credentials, external to a client application (e.g. a web browser) and simple agents may be used to overlay an existing client-server system (e.g. web-based applications). Using an overlay, the agents may automatically provision and/or authenticate a client application to a server application using temporary credentials without significant changes to either the client (e.g. web browser) or server (e.g. web application). The inventors have realised that temporary credentials can be generated “on the fly” by providing strong credentials to a back-end agent when access to a server application is required. The strong credentials are preferably certificate based credentials.

By providing a mechanism to leverage these strong credentials, the present invention enables many advantages and features, such as useability, security and manageability.

Advantages relating to useability include, without limitation:
Ability to use the same strong credentials for multiple applications, thus enabling federated login
System setup only requires relatively standard browser environment, such as Java
Use with any browser as there are no browser specific requirements
May use portable credentials e.g. keystore on a Universal Serial Bus (USB) drive

Advantages relating to security include, without limitation:
Strong authentication of the user
Applications are safer as passwords become one-time and thus mitigate replay attacks and password stealing attacks
Reduced risk for client-server applications that use simple credentials to authenticate over a non secure channel
Accounts are controlled so that only legitimate accounts get created and avoids the problem of “pam” accounts
No need for a trusted central server such as a single-sign-on server, account management server, identity provider server etc.
Requires a relatively small amount of trust as the present invention only requires an account provisioning interface which is easily audited.

Advantages relating to manageability include, without limitation:
Only requires minor environmental changes to existing client or server applications to get certificate based authentication
Automatic recognition of new users
On-the-fly provisioning of accounts so that they do not need to be setup prior to first use of the application
Automatic de-provisioning of users who have had their identification revoked
The application does not have to deal with password related management issues such as reset and reminders.
Has wide applicability because it can work with “traditional” websites that use simple credentials, such as account name and password.
Is distributed and therefore may scale well
Is relatively simple making it easy to deploy.
Is relatively stateless and so does not require a separate database
Can accommodate different naming schemes in the Distinguished Name (DN) of certificates and related account names

Throughout this specification, the term “web” refers to the World Wide Web, a hypertext system that operates over the Internet. Web based systems may include, without limitation, web browsers, web pages, websites, web servers, web services etc. The term “web” within the scope of the present invention does not include restricted access network(s), such as intranet(s).

Further scope of applicability of embodiments of the present invention will become apparent from the detailed description given hereinafter. However, it should be understood that the detailed description and specific examples, while indicating preferred embodiments of the invention, are given by way of illustration only, since various changes and modifications within the spirit and scope of the disclosure herein will become apparent to those skilled in the art from this detailed description.

### BRIEF DESCRIPTION OF THE DRAWINGS

Further disclosure, objects, advantages and aspects of preferred and other embodiments of the present application may be better understood by those skilled in the relevant art by reference to the following description of embodiments taken in conjunction with the accompanying drawings, which are given by way of illustration only, and thus are not limitative of the disclosure herein, and in which:

FIGS. 1a to 1d illustrate various prior art arrangements; and

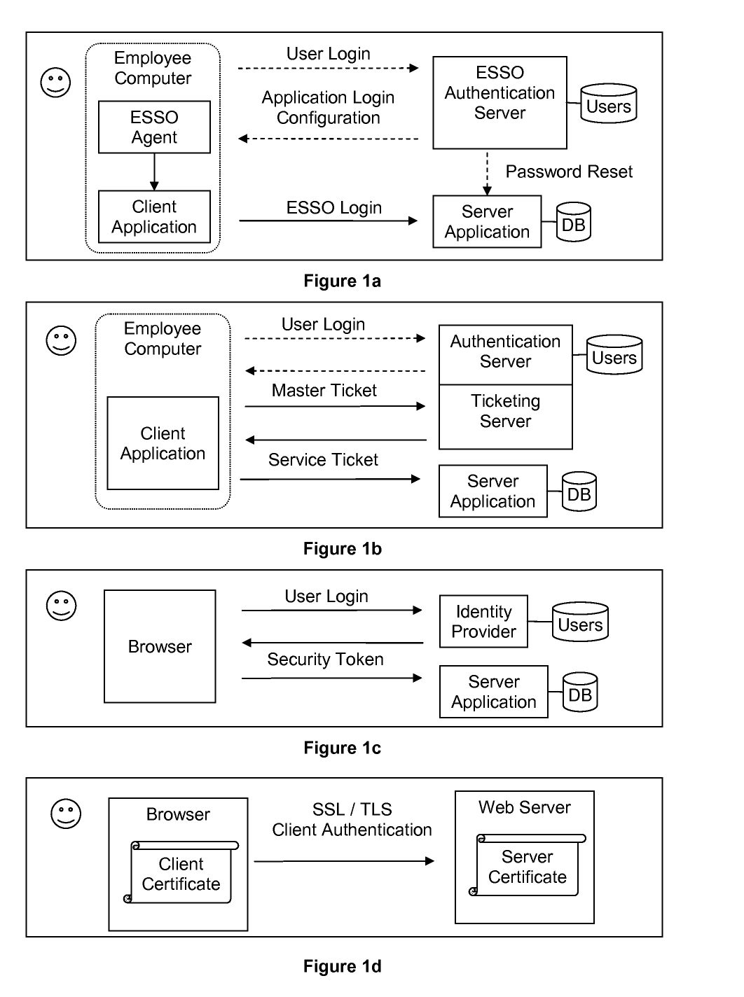

FIG. 2 illustrates an embodiment of the present invention.

### DETAILED DESCRIPTION

### Components

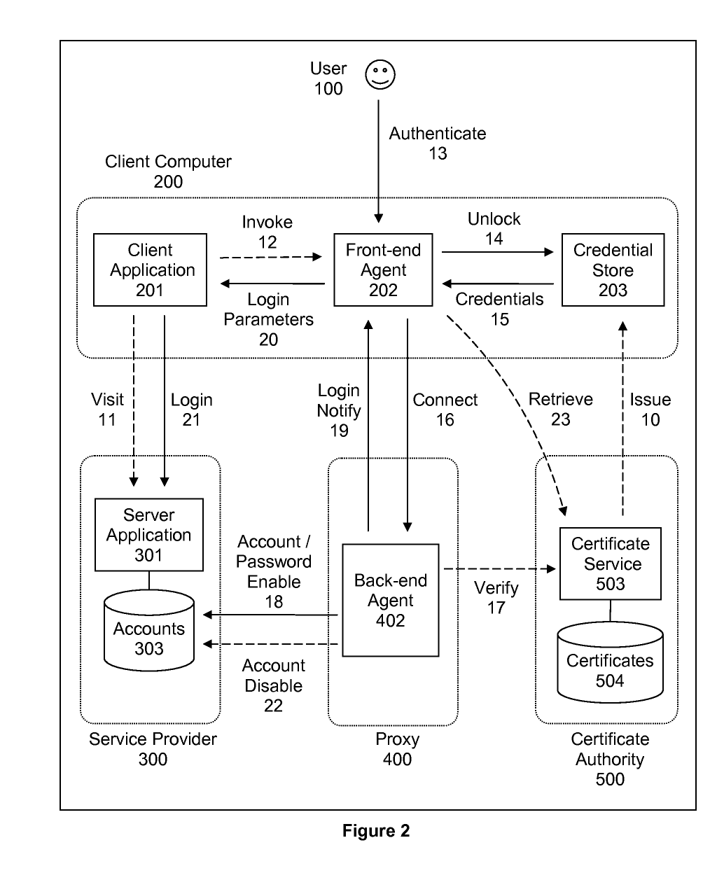

FIG. 2 shows an embodiment of the present invention.

User 100 is a person or other interface which uses a Client Computer 200 to interact with a Service Provider 300 and/or a Certificate Authority 500. A Client Computer 200 and/or a Service Provider 300 and/or a Proxy 400 and/or a Certificate Authority 500 may be co-located and/or may share the same hardware.

Client Computer 200 may be any capable device including desktop computer, mobile phone, personal digital assistant (PDA) etc. Client Computer 200 may contain more than one Client Application 201, Front-end Agent 202 and/or Credential Store 203.

Service Provider 300 may be any remote service provider such as website or computer on a network. Service Provider 300 may contain more than one Application 301 and/or stores of Accounts 303. Service Provider 300 may provide a direct Interface to Accounts 303 such as via Structured Query Language (SQL), an Application Programming Interface—(API), a web service or other account provisioning interface.

Proxy 400 may be any system that can run the Back-end Agent 402. Proxy 400 may have a trusted relationship with Service Provider 300 and/or be provided by Service Provider 300.

Certificate Authority 500 may be an entity that provides a Certificate Service 503, for example to issue and manage digital certificates. It may be a trusted third party and may be part of a public key infrastructure (PKI) or other Web of Trust.

Client Application 201 may be an interface to a User 100 (e.g. a web browser, text interface, graphical interface etc) or another application (e.g a web service, local process etc) which interacts with a Server Application 301.Front-end Agent 202 may be used to Authenticate 13 User 100 and provide Login . Parameters 20 to Client Application 201. During Authentication 13, the Front-end Agent 202 may access Credential Store 203 and may communicate with Back-end Agent 402 and/or Certificate Service 503. The Front-end Agent 202 may be configured with trust anchor certificates from Certificate Service 503. The Front-end Agent 202 may be relatively simple and may be instantiated dynamically from Client Application 201.

Credential Store 203 may store strong credentials for User 100. Typically these credentials are certificate based credentials and Credential Store 203 may contain separate credentials for communications, signing and encryption. Some or all of the credentials may be issued by Certificate Authority 500. The Credential Store 203 may be In software which is stored locally and/or stored on an attached device and/or the Credential Store 203 may use hardware such as using a hardware token or Hardware Security Module (HSM).

Server Application 301 is any application that provides services to a Client Application 201. Typically Server Application 301 is a web application. The Server Application 301 may have associated storage, such as a store or database of Accounts 303 and other related user information such as passwords, preferences, personalisation etc.

Back-end Agent 402 may be used to obtain an identifier from the Front-end Agent 202 representing User 100. The Back-end Agent 402 may use information in a certificate supplied from the Front-end Agent 202 to obtain the identifier. Such information may include all or part of the Certificate Subject and/or Issuer and/or Serial Number and/or other mechanism such as predetermined criteria. The Back-end Agent 402 may be configured with trust anchor certificates from Certificate Service 503. The Back-end Agent 402 may be relatively simple in that it does not necessarily need to have local storage, such as for users, accounts, configuration etc.

The Certificate Service 503 may be used to Issue 10 certificates to User 100 which are stored in Credential Store 203. Certificate Service 503 may keep a local database of issued Certificates 504 and may offer a revocation service such as Online Certificate Status. Protocol (OCSP) or Certificate Revocation Lists (CRLs) to Verify 17 if a certificate is valid or has been revoked.

### Operation

In overview, an embodiment of the present invention may overlay an existing client-server system (e.g. on the web) which uses a native login mechanism (e.g. name and password) with agents and strong credentials (e.g. certificate based credentials) to provide strong authentication, federated login and automated provisioning without requiring significant modification to either the client (e.g. web browser) nor server (e.g. web application).

Prior to using Server Application 301, a User 100 may have used a Certificate Service 503 in order to obtain strong credentials. The Certificate Service 503 may Issue 10 strong credentials, such as certificate based credentials, to User 100 and these strong credentials may be stored in a Credential Store 203 and/or stored remotely, for example in an escrow service provided by Certificate Service 503.

User 100 may Authenticate 13 to Front-end Agent 202. The Front-end Agent 202 may be downloaded dynamically such as from Service Provider 300 and may be implemented as active content such as a Java applet, browser object, script, etc. The running of Front-end Agent 202 may be triggered in various ways, including by a Visit 11 to Server Application 301, by the User 100, by the Client Application 201, or by another system running on Client Computer 200. Additionally, Credential Store 203 may remain unlocked for a predetermined period of time, for example so that the User 100 does not have to Authenticate 13 each time a Server Application 301 is used.

Front-end Agent 202 may use authentication information obtained from User 100 to Unlock 14 a Credential Store 203. The Credential Store 203 may also be unlocked by other means, such as the use of a smart card or hardware token having the Credential Store 203. If a Credential Store 203 is not available, then Front-end Agent 202 may Retrieve 23 credentials from an escrow service provided by Certificate Service 503. Authentication 13 information provided by User 100 may be an identifier such as a name or an email address and other proof of identity such as a password or passphrase. The Front-end Agent 202 may conveniently derive some information, such as an identifier, for example by checking for credentials installed on Client Computer 200, so that User 100 does not have to manually enter it.

Front-end Agent 202 may use Credentials 15 from the Credential Store 203, such as keys, to Connect 16 with a Back-end Agent 402. The connection may be secure such as using Secure Sockets Layer (SSL) or Transport Layer Security (TLS) and may pass a certificate of User 100. Front-end Agent 202 may verify the Back-end Agent 402 using embedded trusted certificates from the Certification Authority 500.

Back-end Agent 402 may verify Connect 16 from Front-end-Agent 202 using embedded trusted certificates from the Certification Authority 500. Back-end. Agent 402 may close the connection if it cannot verify Front-end Agent 202 or the certificate of User 100. Otherwise, Back-end Agent 402 may extract information from the user certificate which identifies the user and from which an account name can be derived.

Back-end Agent 402 may Verify 17 that User 100 has not been revoked by Certificate Service 503. If User 100 has been revoked, then Back-end Agent 402 may close the Connection 16 and Account Disable 22, such as lock, suspend or remove the account associated with User 100 from the store of Accounts 303. Back-end Agent 402 may use a remote interface to Accounts 303, such as an account provisioning interface.

Once the Back-end Agent 402 has verified User 100, it may Account / Password Enable 18 that User 100 in Accounts 303. If an account does not exist, then Back-end Agent 402 may automatically create or provision an account. If the account is locked or disabled, then Back-end Agent 402 may unlock it or enable it respectively. If the account requires a password, then Back-end Agent 402 may set a random and/or temporary and/or one-time password. This password may be generated using the Front-end Agent 202, and/or Back-end Agent 402 and/or an interface to Accounts 303 for example a password generated by a password reset.

Once the account is enabled; the Back-end Agent 402 may Login Notify 19 the Front-end Agent 202 with parameters necessary to login to Server Application 301.

Front-end Agent 202, may then pass Login Parameters 20 to Client Application 201. For example, Login Parameters 20 may be an account name and one-time password.

Client Application 201 may Login 21 to Server Application 301 using Login Parameters 20. For example, Login 21 by passing Login Parameters 20 via a Hypertext Transfer Protocol (HTTP) Get or Put operation. In another example, Client Application 201 may be a non-interactive service such as web service and use Login Parameters 20 to form a Login 21 request or authentication request to Server Application 301. The Login 21 may use transport security such as SSL or TLS.

After logging in, the session may become a regular logged in session and Client Application 201 may interact with Server Application 301 as required. Benefits

The present invention enables many benefits, advantages and features. To help illustrate some of these, the following paragraphs take the example of a user (User 100), web browser (Client Application 201), web application (Server Application 301) and website (Service Provider 300).

In terms of deployment, the present invention may be relatively easy to implement. For the user, there may be no changes required to the browser and may be nothing to install as the Front-end Agent 202 may be dynamically downloaded as part of accessing a website. Because no changes may be required to the web browser, a user may use just about any web browser, operating system and computing platform including mobile devices. For the website, there may be no changes required to existing web applications, just the ability to serve up a page containing a Front-end Agent 202 and access to an interface for Back-end Agent 402 to setup and manage Accounts 303, such as create, reset, disable etc. The Back-end Agent 402 may be run as a simple standalone application within Service Provider 300 or may use a remote account provisioning interface provided by Service Provider 300 from a separate Proxy 400.

In terms of maintenance, the present invention may reduce administration and support. The website may continue to use existing simple login mechanisms but may avoid many of the processes around account management, user registration, password reminders, password reset etc. This may significantly reduce help desk costs as these costs are often dominated by account and password related issues. Also, other password management features may no longer be required, such as externally visible password reset and security questions. The leveraging of an external registration process, such as that used by Certificate Authority 500 may reduce unwanted accounts, such as web robots registering “spam” accounts, and reduce expired accounts, such as those associated with users that have been revoked.

In terms of user experience, the present invention may simplify the users interactions with a website. The ability to automatically login to a website is convenient and avoids the user having to remember the account name and password for a particular website or rely to on a browser to cache this information. The single-sign-on capability means that the one set of credentials may be used for multiple websites which avoids the user having to remember and maintain multiple accounts and passwords for those websites. If the user travels or uses different computers, then they may simply use a portable device containing their Credential Store 203 or use an escrow facility of the Certificate Service 503.

In terms of website business, the present invention may be advantageous to the website owner. For example, the automated login capability means one less step in order to engage existing users. Leveraging an existing registered user base may help with customer acquisition, as new users are often deterred by a registration process. The federated login capability may also simplify interworking with partner sites e.g. a website that has outsourced billing and/or support to another site.

In terms of user security, the present invention may improve authentication and identification. Authentication is improved using strong credentials, such as certificate-based credentials, as it is usually better than account and password mechanisms commonly provided by websites. Identification may be much stronger as a Certificate Authority 500 usually has stronger processes around proof of identity, issuance of certificates, generation of keys and revocation. Also, because the present invention avoids installing certificates into a browser, it avoids the problem of anyone using that browser being identified with those credentials and the problem of removing user certificates from a browser when no longer required.

In terms of website security, the present invention may make a website more resilient to attacks. This may be relatively significant if the website does not make use of transport security, such as SSL or TLS. The use of one-time passwords may mitigate account/password stealing and password replay attacks as the password is not reused. The one-time password may be very strong (say a random 20 bytes) so that dictionary attacks and other guessing attacks may become impractical. After first use, the account may be safely disabled and/or timed out, such as in a few minutes which minimises the window of opportunity for a man-in-the-middle attack. Further, an account login may be disabled when a wrong password is tried, which further limits an attacker trying to guess the password.

In another example, the present invention enables non-interactive applications (e.g. web services) to make use of strong credentials to access a Server Application 301. For example, a web service can leverage strong credentials but still continue to operate with existing simple authentication, such as name and password, in a way similar to that described above.

### General

While this invention has been described in connection with specific embodiments thereof, it will be understood that it is capable of further modification(s). This application is intended to cover any variations uses or adaptations of the invention following in general, the principles of the invention and including. such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

It should be noted that where the terms “server”, “secure server” or similar terms are used herein, a communication device is described that may be used in a communication system, unless the context otherwise requires, and should not be construed to limit the present invention to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the invention, it should not be construed to limit the present invention to any particular logic flow or logic implementation. The .described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of the invention may be embodied in many different forms, including computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, EcmaScript or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g. a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL). Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies,—optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM.or fixed disk), or distributed from a server or electronic bulletin board over the communication system (e.g., the Internet or World Wide Web).

“Comprises/comprising” and “includes/including” when used in this specification is taken to specify the presence of stated features, integers, steps or components but does not preclude the presence or addition of one or more other features, integers, steps, components or groups thereof. Thus, unless the context clearly requires otherwise, throughout the description and the claims, the words ‘comprise’, ‘comprising’, ‘includes’, ‘including’ and the like are to be construed in an inclusive sense as opposed to an exclusive or exhaustive sense; that is to say, in the sense of “including, but not limited to”.

Throughout this specification the use of words in singular form may be taken as reference to words in plural and vice versa.

1. A method of generating a temporary authentication credential adapted to enable access to a remote service, the method comprising the steps of:
providing a certificate based credential
thereafter generating a temporary authentication credential for use in the access of the remote service.

2. A method as claimed in claim 1, wherein a user is authenticated using a certificate based credential.

3. (canceled)

4. A method as claimed in claim 1, wherein a plurality of remote services are accessed, each remote service having a respective temporary credential.

5. (canceled)

6. A method as claimed in claim 1, wherein the temporary credential comprises an identifier and/or password.

7-11. (canceled)

12. A method as claimed in claim 1, wherein the client triggers the generation of the credential.

13. A method as claimed in claim 1, wherein the client transmits the credential to the remote service.

14. A method as claimed in claim 1, wherein the certificate based credential is stored separate to the client.

15. A method as claimed in claim 1, wherein the temporary credential is generated remote from the remote service.

16. A method as claimed in claim 1, wherein the authentication of the certificate based credential is separate to the client.

17. A method of enabling access to a remote service, comprising:
generating a temporary authentication credential
providing to the remote service, the temporary credential
providing the temporary credential to the client for use in enabling access to the remote service

18. A method as claimed in claim 17, wherein the temporary credential is generated to enable access to a remote service, according to the steps of:
providing a certificate based credential
thereafter generating a temporary authentication credential for use in the access of the remote service.

19. A method as claimed in claim 17, wherein the temporary credential is used the client to enable access.

20. (canceled)

21. A method as claimed in claim 17, wherein the remote service is a website.

22. (canceled)

23. A method as claimed in claim 17, wherein the temporary credential comprises an identifier and/or password

24. (canceled)

25. A computer system adapted to enable access to a remote service, the system comprising:
Logic means adapted to receive a certificate based credential
Authentication means adapted to generate a temporary authentication credential for use in the access of the remote service.

26. A system as claimed in claim 25, further comprising:
Communication means adapted communicate to the remote service, the temporary credential,
Transmission means adapted to transmit the temporary credential to the client for use in enabling access to the remote service.

27. A system as claimed in claim 25, adapted to enable the generation of a temporary credential wherein the temporary credential is generated to enable access to a remote service, according to the steps of:
providing a certificate based credential
thereafter generating a temporary authentication credential for use in the access of the remote service.

28. In combination a system as claimed in claim 25 and a content management system, a messaging system, a file management system, a systems management system and/or a collaboration system.

29. An application adapted to enable encryption and/or decryption of content, said application comprising a predetermined instruction set adapted to enable a method as claimed in claim 1.

30-32. (canceled)
